(19) United States
(12) Patent Application Publication
(10) Pub. No.: US 2026/0235280 A1
(43) Pub. Date: Aug. 13, 2026

(54) LIGHTING ASSEMBLY

(71) Applicant: Dukesea PTY Limited, Bellingen, New South Wales (AU)

(72) Inventor: Sinclair PARK, Bellingen, New South Wales (AU)

(73) Assignee: Dukesea PTY Limited, Bellingen, New South Wales (AU)

(21) Appl. No.: 19/158,066

(22) PCT Filed: Feb. 15, 2024
(86) PCT No.: PCT/AU2024/050100

§ 371 Date: Aug. 20, 2025

(30) Foreign Application Priority Data
Feb. 20, 2023 (AU) 2023900423

(51) Int. Cl. F21V 19/00; F21Y 115/10

(52) U.S. Cl. CPC F21V 19/003; F21V 19/0015; F21Y 2115/10

(57) ABSTRACT

A lighting assembly (1/1′) and a method of assembling a lighting assembly (1/1′). The lighting assembly includes a body (10/10′) including an aperture (11), and a light emitting module (20/20′) to be inserted in said aperture (11) of said body (10/10′). The body (10/10′) is formed of a substantially thermally conductive material. The light emitting module (1/1′) includes a metal core printed circuit board (21), and a light emitting element (22) mounted to the metal core printed circuit board (21).

### FIELD OF THE INVENTION

The present invention relates to a lighting assembly and a method of assembling a lighting assembly.

In particular, the present invention relates to a solid-state lighting assembly, and, to a lighting assembly method for accurately positioning an MCPCB-base LED module within a very small luminaire, and for also providing high conductivity thermal connection between the module and the luminaire.

The present invention further provides a lighting assembly method for accurately positioning an MCPCB-base LED module within a luminaire, where space and/or access may be limited.

### BACKGROUND OF THE INVENTION

Any reference herein to known prior art does not, unless the contrary indication appears, constitute an admission that such prior art is commonly known by those skilled in the art to which the invention relates, at the priority date of this application.

To integrate a high power (>1 W) Light Emitting Diode (LED) module or light engine into a luminaire, there should be an electrical connection, a mechanical fixing, a location method, a heat dissipation path, and, one or more optical elements.

In recent times, high-power LEDs are becoming smaller and more powerful, with some Chip Scale Packages (CSP) being as small as 1.6 mm×1.6 mm and having a maximum wattage which can be as high as 10 W. These small form factor high-power LEDs allow for smaller and/or higher-powered luminaires to be theoretically possible and viable.

However, as luminaires become smaller, there are increased difficulties in achieving all the above requirements in a way that is both physically practical and economically viable. In particular, as luminaires become smaller and/or higher-powered, the heat dissipation path often becomes even more crucial, due to the reduced mass and exposed surface area of the smaller-sized luminaire.

Current methods typically rely on the use of metal core printed circuit boards (MCPCBs) for optimal heat dissipation, often fixing the MCPCB either using mechanical fixing methods such as screws or threaded parts, or thermally adhesive potting compounds. However, these options add complexity to the manufacturing process, and, require extra space from the luminaire to be correctly performed. In addition, these options also lack repeatability in terms of positioning accuracy of the MCPCB in the luminaire.

Thus, there is a need for a method by which a high-power LED (or LEDs) mounted on a very small (typically less than or equal to 10 mm wide) MCPCB can be easily and accurately located in a small luminaire, while also maximizing the heat dissipation path, whilst also providing sufficient space in the small luminaire for electrical connections to be configured.

### SUMMARY OF THE INVENTION

The present invention seeks to overcome at least some of the disadvantages of these aforementioned problems.

In a broad form, the present invention provides a lighting assembly including:
a body including an aperture, the body being formed of a substantially thermally conductive material;
a light emitting module adapted to be inserted in said aperture, the light emitting module including:
   a metal core printed circuit board; and
   a light emitting element mounted to the metal core printed circuit board.

Preferably, the aperture is sized such that the internal diameter of the aperture is substantially equal to or less than the width of the metal core printed circuit board.

Further preferably, the aperture is tapered or chamfered.

Further preferably, the leading edge of the metal core printed circuit board is tapered or chamfered.

Further preferably, the metal core printed circuit board is at least partially deformed when it is received in the aperture.

In an example embodiment, the light emitting element is mounted on the metal core printed circuit board.

In a further example embodiment, the light emitting element is mounted to an end of the metal core printed circuit board.

Further preferably, the light emitting element is thermally connected to the metal core printed circuit board via a substantially centrally located and electrically isolated thermal pad.

In an example embodiment, the orientation of the light emitting element is substantially perpendicular to the axis of the aperture.

In a further example embodiment, the orientation of the light emitting element is substantially parallel to the axis of the aperture.

Preferably, the metal core printed circuit board includes one or more substantially straight cut or routed cut edges.

Preferably, the metal core printed circuit board includes one or more V-cut or V-score edges.

Preferably, the metal core printed circuit board includes one or more fingernail-shaped or convex-shaped edges.

Preferably, the metal core printed circuit board of the light emitting module is further mounted with any one or combination of:
a surface mount device connector;
a resistor;
a shunt; and
one or more other surface mount device components.

Preferably, the metal core printed circuit board has a width of substantially equal to or less than 10 mm.

Preferably, the lighting emitting element is a light emitting diode.

Further preferably, the maximum power of the light emitting diode is in the range of 1 to 10 Watts.

Further preferably, the dimension of the light emitting diode is approximately 1.6 mm×1.6 mm.

Preferably, the metal core printed circuit board is substantially rectangular-shaped.

Preferably, the metal core printed circuit board is at least partially formed of any one or combination of copper, gold, silver, aluminium and platinum.

Preferably, the body is substantially formed of a metal material, including, but not limited to, any one or combination of copper, gold, silver, aluminium and platinum.

In a further broad form, the present invention provides a body for a lighting assembly, the body being formed of a substantially thermally conductive material and includes an aperture.

Preferably, the aperture is tapered or chamfered.

Preferably, the body is substantially formed of a metal material, including, but not limited to, any one or combination of copper, gold, silver, aluminium and platinum.

In a further broad form, the present invention provides a light emitting module for a lighting assembly, including:
a metal core printed circuit board; and
a light emitting element mounted to the metal core printed circuit board.

Preferably, the leading edge of the metal core printed circuit board is tapered or chamfered.

In an example embodiment, the light emitting element is mounted on the metal core printed circuit board.

In a further example embodiment, the lighting element is mounted to an end of the metal core printed circuit board.

Further preferably, the light emitting element is thermally connected to the metal core printed circuit board via a substantially centrally located and electrically isolated thermal pad.

Preferably, the metal core printed circuit board includes one or more substantially straight cut or routed cut edges.

Preferably, the metal core printed circuit board includes one or more V-cut or V-score edges.

Preferably, the metal core printed circuit board includes one or more fingernail-shaped or convex-shaped edges.

Preferably, the metal core printed circuit board of the light emitting module is further mounted with any one or combination of:
a surface mount device connector;
a resistor;
a shunt; and
or more other surface mount device components.

Preferably, the metal core printed circuit board has a width of substantially equal to or less than 10 mm.

Preferably, the lighting emitting element is a light emitting diode.

Further preferably, the maximum power of the light emitting diode is in the range of 1 to 10 Watts.

Further preferably, the dimension of the light emitting diode is approximately 1.6 mm×1.6 mm.

Preferably, the metal core printed circuit board is substantially rectangular-shaped.

Preferably, the metal core printed circuit board is at least partially formed of any one or combination of copper, gold, silver, aluminium and/or platinum.

In a further broad form, the present invention relates to a method of assembling a lighting assembly, the lighting assembly including:
a body including an aperture, the body being formed of a substantially thermally conductive material;
a light emitting module adapted to be inserted in said aperture, the light emitting module including:
   a metal core printed circuit board; and
   a light emitting element mounted to the metal core printed circuit board,
      wherein the method includes the steps of:
press fitting the light emitting module into the aperture of the body.

Preferably, the metal core printed circuit board is at least partially deformed when the light emitting module is fitted in aperture of the body.

Preferably, the method further includes the preliminary step of:
attaching or loading the light emitting module onto a jig.

Further preferably, the method further includes the step of:
detaching or extracting the light emitting module from the jig.

Preferably, the method further includes the step of:
filling the remainder of the aperture of the body with an epoxy.

Further preferably, the epoxy is formed of a substantially thermally conductive material such as ceramic, and preferably formed of a substantially electrically insulative material.

Preferably, the method further includes the preliminary step of:
cutting one or more edges of the metal core printed circuit board with a substantially straight cut, routed cut, fingernail-shaped/convex-shaped edge cut and/or V-cut process.

Preferably, the method further includes the preliminary step of:
cutting the leading edge of the metal core printed circuit board into a tapered or chamfered form.

Preferably, the method further includes the preliminary step of:
drilling the aperture of the body into an undersized, tapered and/or chamfered form,
   wherein the aperture is undersized such that the internal diameter of the aperture is substantially equal to or less than the width of the metal core printed circuit board.

In an example embodiment, the light emitting element is mounted on the metal core printed circuit board.

In a further example embodiment. the light emitting element is mounted to an end of the metal core printed circuit board.

Further preferably, the light emitting element is thermally connected to the metal core printed circuit board via a substantially centrally located and electrically isolated thermal pad.

In an example embodiment, the orientation of the light emitting element is substantially perpendicular to the axis of the aperture.

In a further example embodiment, the orientation of the light emitting element is substantially parallel to the axis of the aperture.

Preferably, the metal core printed circuit board of the light emitting module is further mounted with any one or combination of:
a surface mount device connector;
a resistor;
A Shunt; And
one or more other surface mount device components.

Preferably, the metal core printed circuit board has a width of substantially equal to or less than 10 mm.

Preferably, the lighting emitting element is a light emitting diode.

Further preferably, the maximum power of the light emitting diode is in the range of 1 to 10 Watts.

Preferably, the dimension of the light emitting diode is approximately 1.6 mm×1.6 mm.

Preferably, the metal core printed circuit board is substantially rectangular-shaped.

Preferably, the metal core printed circuit board is at least partially formed of any one or combination of copper, gold, silver, aluminium and platinum.

Preferably, the body is substantially formed of a metal material, including, but not limited to, any one or combination of copper, gold, silver, aluminium and platinum.

### BRIEF DESCRIPTION OF THE DRAWINGS

The present invention will become more fully understood from the following detailed description of preferred but non-limiting embodiments thereof, described in connection with the accompanying drawings, wherein:

FIGS. 1 and 2 illustrate, respectively, isometric and cross-sectional views of a first exemplary embodiment of the lighting assembly, when it is mounted to a fitting aperture of a handrail or tube;

FIG. 3 illustrates a first isometric view of the lighting assembly shown in FIGS. 1 and 2;

FIG. 4 illustrates a second isometric view of the lighting assembly shown in FIG. 3;

FIG. 5 illustrates a side view of the lighting assembly shown in FIGS. 3 and 4;

FIG. 6 illustrates a first isometric view of a first example of how a light emitting module is installed in a body of a lighting assembly, when it is in a substantially detached or separated state;

FIG. 7 illustrates a second isometric view of the first example shown in FIG. 6, when it is in a substantially attached or connected state;

FIG. 8 illustrates a top view of the first example shown in FIG. 7;

FIG. 9 illustrates a cross-sectional view of section A-A of the first example shown in FIGS. 7 and 8;

FIG. 10 illustrates a first isometric view of a second example of how a light emitting module is installed in a body of a lighting assembly, when it is in a substantially detached or separated state;

FIG. 11 illustrates a second isometric view of the second example shown in FIG. 10, when it is in a substantially attached or connected state;

FIG. 12 illustrates a top view of the second example shown in FIG. 11;

FIG. 13 illustrates a cross-sectional view of section B-B of the second example shown in FIGS. 11 and 12;

FIG. 14 illustrates an isometric view of a first example embodiment of the light emitting module, which is used in the first example shown in FIGS. 6 to 9;

FIG. 15 illustrates an isometric view of a second example embodiment of the light emitting module, which is used in the second example shown in FIGS. 10 to 13;

FIGS. 16 and 17 illustrate, separately, isometric views of the light emitting module of third and fourth example embodiments of the light emitting module;

FIGS. 18 to 20 show the steps taken to assemble the first exemplary embodiment of the lighting assembly shown in FIGS. 3 to 5.

FIG. 21 illustrates an isometric view of a second exemplary embodiment of the lighting assembly;

FIG. 22 illustrates a bottom view of the lighting assembly shown in FIG. 21;

FIG. 23 illustrates a side view of the lighting assembly shown in FIGS. 21 and 22;

FIG. 24 illustrates a cross-section view of section C-C of the lighting assembly shown in FIGS. 21 to 23; and

FIG. 25 illustrates the typical use of the lighting assembly shown in FIGS. 21 to 24.

### DETAILED DESCRIPTION OF PREFERRED EMBODIMENTS

Throughout the drawings, like numerals will be used to identify similar features, except where expressly otherwise indicated.

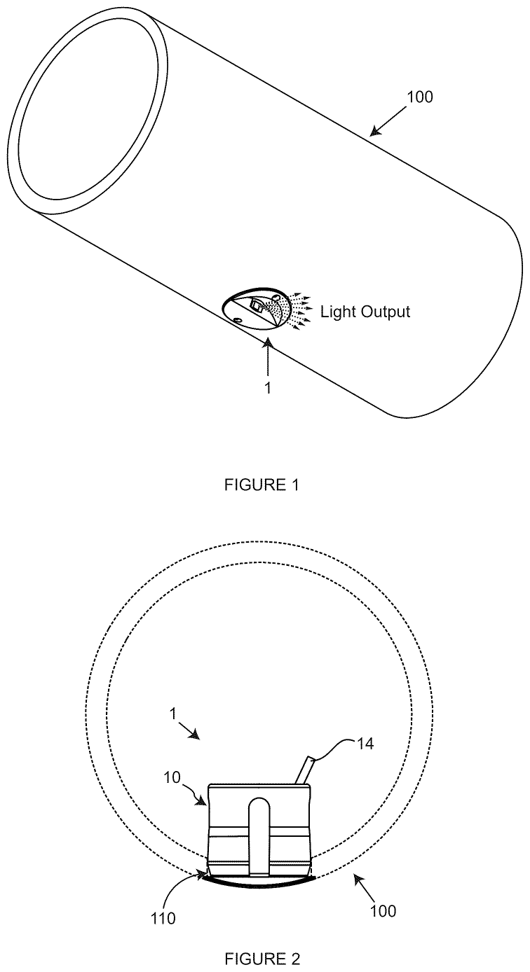

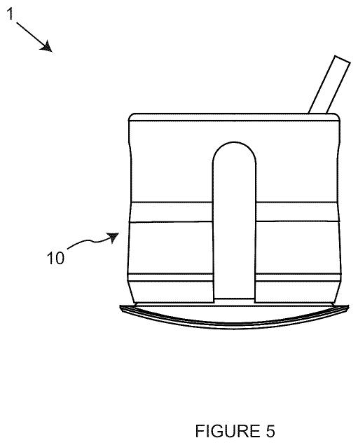

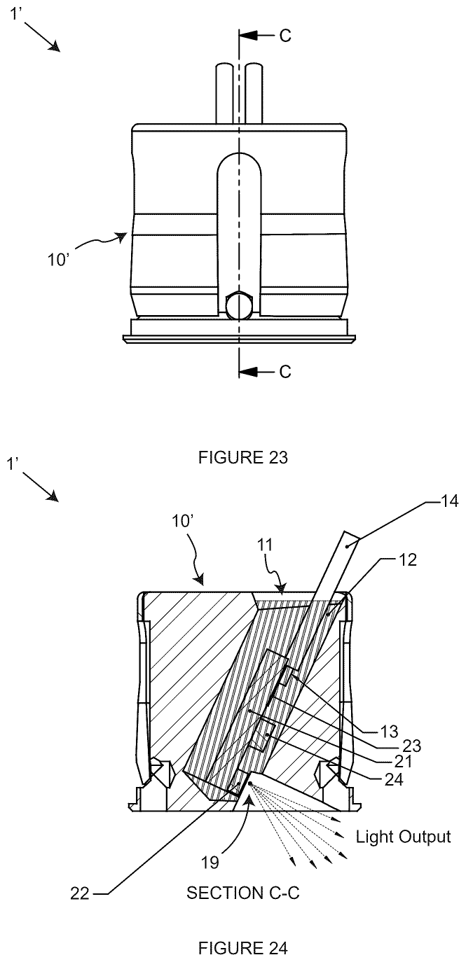

FIGS. 1 to 25 show various embodiments of a lighting assembly (1/1′) for mounting in a fitting aperture, such as in a handrail or tube (100). The lighting assembly (1/1′) typically includes a body (10/10′) that has an aperture (11), and a light emitting module (20/20′) that is adapted to be received by the aperture (11) of the body (10/10′). The body (10/10′) of the lighting assembly (1/1′) is typically made of a substantially thermally conductive material such as metal. In addition, the light emitting module (20/20′) would typically include a metal core printed circuit board (MCPCB) (21), and a light emitting element (22) that is mounted to the MCPCB (21).

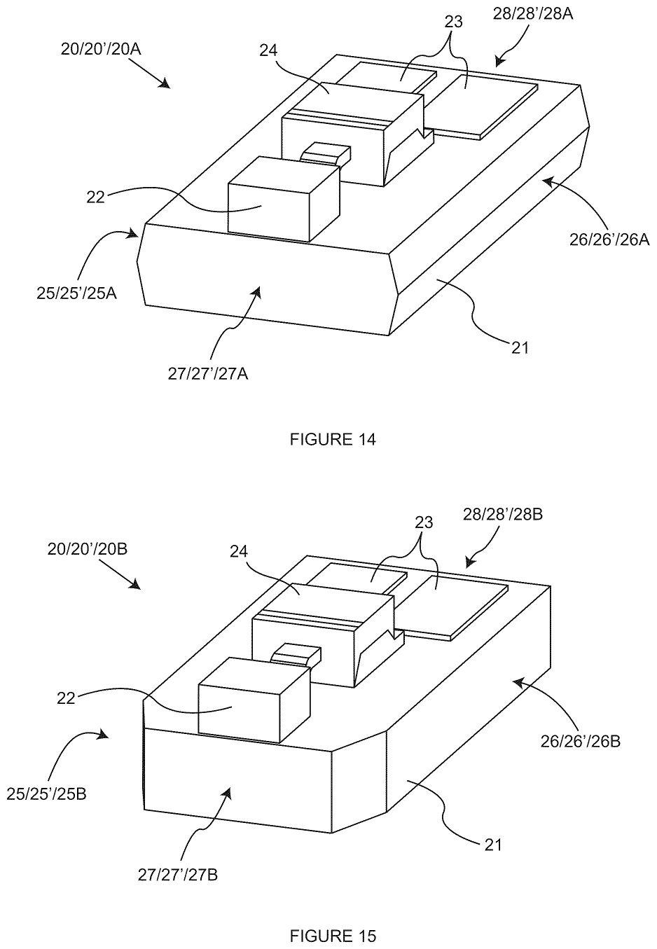

Referring to FIGS. 14 to 17, the MCPCB typically includes first and second side regions (25/25′, 26/26′) and front and rear regions (27/27′, 28/28′), such that the width of the MCPCB is defined by the distance between the first side region (25/25′) and the second side region (26/26′). Specifically, the first and second side regions (25/25′, 26/26′) of the MCPCB (21) are adapted to substantially abut respective portions of the internal surface of the body (10/10′), located near or at the aperture (11), when the MCPCB (21) is received by the aperture (11) of the body (10/10′).

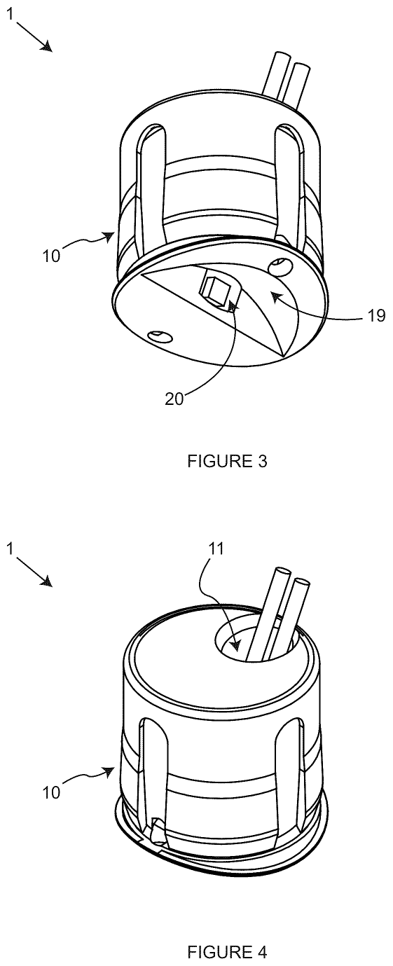

In FIGS. 1 to 5, a first exemplary embodiment of the lighting assembly (1) is illustrated, with FIGS. 1 and 2 showing the lighting assembly (1) being mounted in a handrail or tube (100), and FIGS. 3 to 5 showing the lighting assembly (1) being unmounted from the handrail or tube (100). In FIGS. 3 to 5, the lighting assembly (1) is in a substantially attached or connected state, which is when the light emitting module (20) is fitted into the aperture (11) of the body (10) of the lighting assembly (1). Particularly, the body (10) of the first exemplary embodiment of the lighting assembly (1) has a curved bottom with a recess (19), which allows the light emitting module (20) to emit light in the direction of the “Light Output” arrows.

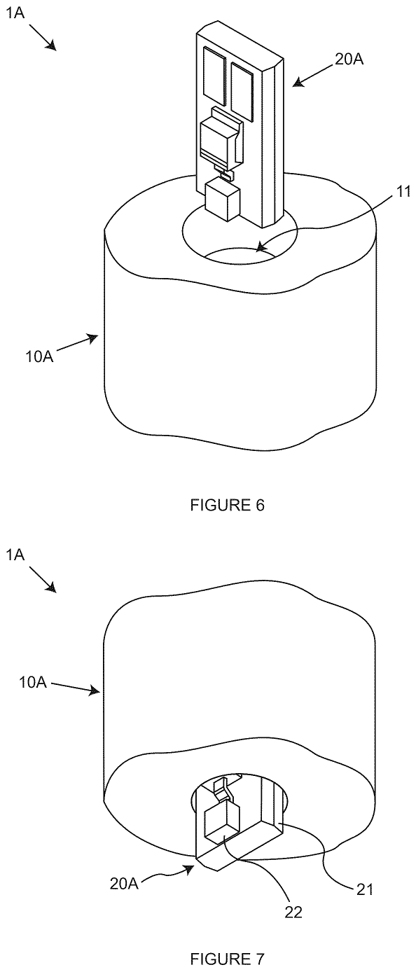

In FIGS. 6 to 9, a first example of how a light emitting module is installed in a body of a lighting assembly is illustrated. As depicted, the first example uses a body (10A) of a generic lighting assembly (1A) as well as a first example embodiment of a light emitting module (10A), which is more clearly shown in FIG. 14. The first example is one of the installation options that may be used in the first exemplary embodiment of the lighting assembly (1).

In FIG. 6, it is illustrated of the generic lighting assembly (1A) being in a substantially detached or separated state, with the light emitting module (20A) not being located in the aperture (11) of the body (10A) of the generic lighting assembly (1A). On the other hand, in FIGS. 7 to 9, it is illustrated of the generic lighting assembly (1A) being in a substantially attached or connected state, with the light emitting module (20A) being received by the aperture (11) of the body (10A) of the generic lighting assembly (1A).

Typically, the aperture (11) of the body (10A) is a slightly undersized hole or recess, such that the internal diameter of the aperture (11) is substantially equal to or slightly less than the width of the MCPCB (21). As a result, the MCPCB (21) is caused to slightly deform, when the light emitting module (20A) is fitted into the aperture (11) of the body (10A), so that it can fit in the internal diameter of the slightly undersized aperture (11). Preferably, the light emitting module (20A) is received by the aperture (11) of the body (10A) via an interference fit or press fit.

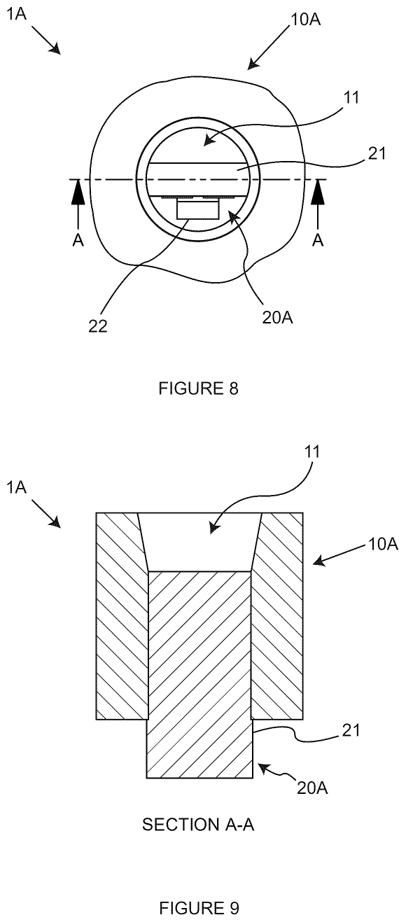

As shown in FIGS. 8 and 9, the slightly deformed MCPCB (21), as opposed to the traditional method of removing material from the MCPCB to fit into the slightly undersized aperture, ensures a greater surface contact, as well as maximum contact pressure, between the MCPCB (21) and the aperture (11), to thereby ensure greater thermal conductivity between the MCPCB (21) of the light emitting module (20A) and the body (10A) of the generic lighting assembly (1A).

As shown in FIG. 9, the aperture (11) of the body (10A) of the generic lighting assembly (1A) has a tapered or chamfered nature which encourages the deformation of the MCPCB (21), when it is inserted in the aperture (11). In addition, as shown in FIGS. 7 and 14, the first example enables the light emitting element (22) to be oriented perpendicularly to the axis of the aperture (11), which can be useful in some applications. Specifically, as shown in FIGS. 7, 8 and 14, the light emitting element (22) is oriented perpendicularly to the axis of the aperture (11) in this example, since the light emitting element (22) is mounted on the MCPCB (21) and emits light substantially away from the MCPCB (21) (such as that shown, for example, in FIG. 1 via the “Light Output” arrows of the first exemplary embodiment of the lighting assembly (1)). The light emitting element (22) may be in the form of a light emitting diode (LED).

As more clearly shown in FIG. 14, the first and second side regions (25A, 26A) of the MCPCB (21) include edges which are created by a process known as V-cut or V-score, which is a method that is commonly used to create “breakable” joints in a panel of MCPCBs. When it comes to optimizing integration with the slightly undersized aperture (11), the V-cut edges of the first and second side regions (25A, 26A) of the MCPCB (21) provide an advantage over straight cut or routed cut edges, as the V-cut edges are a closer approximation of the radius of the aperture (11), and would therefore provide better thermal conductivity, between the MCPCB (21) and the body (10A), than the straight cut or routed cut edges.

Whilst FIGS. 6 to 9 and 14 show the taper or chamfer being applied to the upper portion of the aperture (11), in order for the first example embodiment of the light emitting module (20A) to be more easily inserted into the body (10A) from top to bottom, it would be readily known to the person skilled in the art that the taper and chamfer may be applied instead to the lower portion of the aperture (11), in order for the first example embodiment of the light emitting module (20A) to be reversely inserted into the body (10A) from bottom to top, with the light emitting module (20A) being in the same orientation as that shown in FIGS. 6 and 7.

Further, whilst FIGS. 6 to 9 and 14 show the taper or chamfer being applied to a portion of the aperture (11), it would be apparent to the person skilled in the art that the taper and chamfer may also be applied to substantially the whole length of the aperture (11) and still substantially provide the feature of encouraging/facilitating deformation of the MCPCB (21).

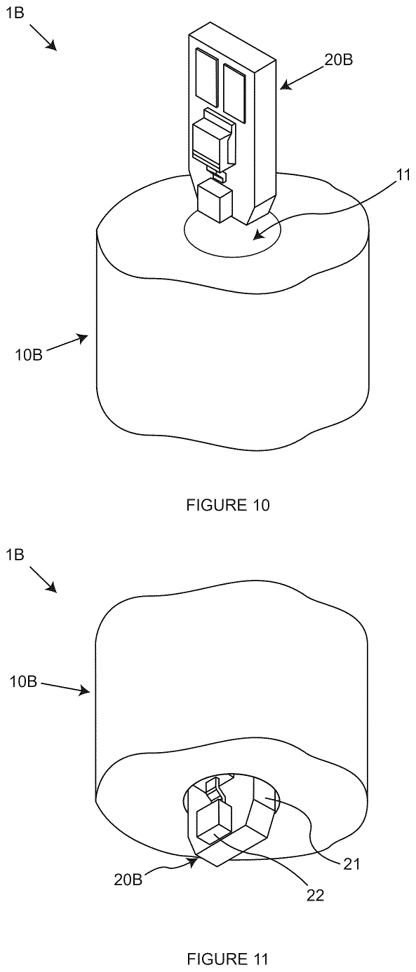

In FIGS. 10 to 13, a second example of how a light emitting module is installed in a body of a lighting assembly is illustrated. As depicted, the second example uses a body (10B) of a further generic lighting assembly (1B) as well as a second example embodiment of a light emitting module (10A), which is more clearly shown in FIG. 15. The second example is one of the installation options that may be used in the first exemplary embodiment of the lighting assembly (1).

In FIG. 10, it is illustrated of the further generic lighting assembly (1B) being in a substantially detached or separated state, with the light emitting module (20B) not being located in the aperture (11) of the body (10B) of the further generic lighting assembly (1B). On the other hand, in FIGS. 11 to 13, it is illustrated of the further generic lighting assembly (1B) being in a substantially attached or connected state, with the light emitting module (20B) being received by the aperture (11) of the body (10B) of the further generic lighting assembly (1B).

Typically, the aperture (11) of the body (10B) is a slightly undersized hole or recess, such that the internal diameter of the aperture (11) is substantially equal to or slightly less than the width of the MCPCB (21). As a result, the MCPCB (21) is caused to slightly deform, when the light emitting module (20B) is fitted into the aperture (11) of the body (10B), so that it can fit in the internal diameter of the slightly undersized aperture (11). Preferably, the light emitting module (20B) is received by the aperture (11) of the body (10B) via an interference fit or press fit.

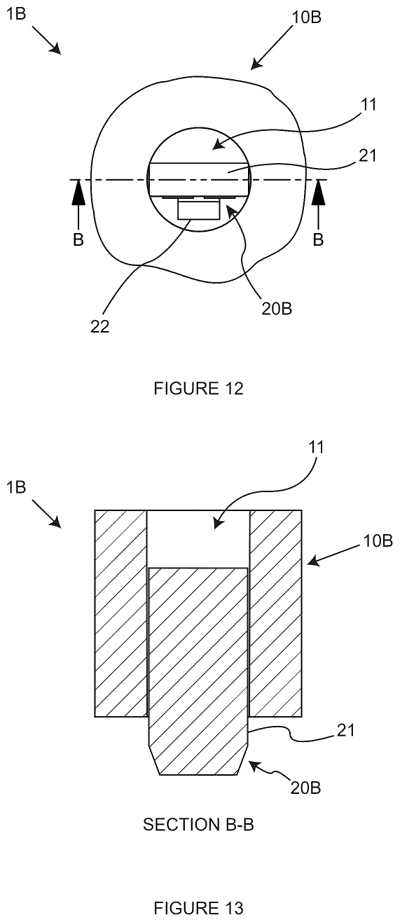

As shown in FIGS. 12 and 13, the slightly deformed MCPCB (21), as opposed to the traditional method of removing material from the MCPCB to fit into the slightly undersized aperture, ensures a greater surface contact, as well as maximum contact pressure, between the MCPCB (21) and the aperture (11), to thereby ensure greater thermal conductivity between the MCPCB (21) of the light emitting module (20B) and the body (10B) of the further generic lighting assembly (1B).

As shown in FIGS. 10, 11, 13 and 15, a taper or chamfer has been applied to the “leading edge” of the MCPCB (21) that first enters the slightly undersized aperture, which is the front region (27B) of the MCPCB (21). The taper or chamfer further assists the deformation of the MCPCB (21) of the light emitting module (20B), and may further optionally remove the need to apply a taper or chamfer to the aperture (11) similar to that shown in FIG. 9 of the first example which uses the generic lighting assembly (1A). Specifically, in the second example, the slightly undersized aperture (11) does not have a taper or chamfer, as clearly shown in FIG. 13.

In addition, as shown in FIGS. 11 and 15, the second example embodiment enables the light emitting element (22) to be oriented perpendicularly to the axis of the aperture (11), which can be useful in some applications. Specifically, as shown in FIGS. 10, 11 and 15, the light emitting element (22) is oriented perpendicularly to the axis of the aperture (11) in this example, since the light emitting element (22) is mounted on the MCPCB (21) and emits light substantially away from the MCPCB (21) (similar to that shown, for example, in FIG. 1 via the “Light Output” arrows of the first exemplary embodiment of the lighting assembly (1)). The light emitting element (22) may be in the form of an LED.

As shown in FIGS. 10, 12 and 15, the first and second side regions (25B, 26B) of the MCPCB (21) have edges which are created by a straight cut process. As further illustrated in FIGS. 12 and 13, a significant residual space is formed between the straight cut edge of the first side region (25B) of the MCPCB (21) and the internal surface of the body (10B), and another significant residual space is formed between the straight cut edge of the second side region (26B) of the MCPCB (21) and the internal surface of the body (10B).

Whilst FIGS. 10 to 13 and 15 show the taper or chamfer being applied to the front region (27B) of the MCPCB (21), in order for the second example embodiment of the lighting emitting module (10B) to be more easily inserted into the body (10B) from top to bottom, it would be readily known to the person skilled in the art that the taper and chamfer may be applied instead to the rear region (28B) of the MCPCB (21), in order for the second example embodiment of the light emitting module (20B) to be reversely inserted into the body (10B) from bottom to top, with the light emitting module (20B) being in the same orientation as that shown in FIGS. 10 and 11.

Further, whilst FIGS. 10 to 13 and 15 show the taper or chamfer being applied to a portion of the MCPCB (21), it would be apparent to the person skilled in the art that the taper and chamfer may also be applied to substantially the whole length of the MCPCB (21) and still substantially provide the feature of encouraging/facilitating deformation of the MCPCB (21). For example, a linear taper may be applied starting from the rear region and ending at the front region of the MCPCB, forming a trapezoidal-shaped MCPCB.

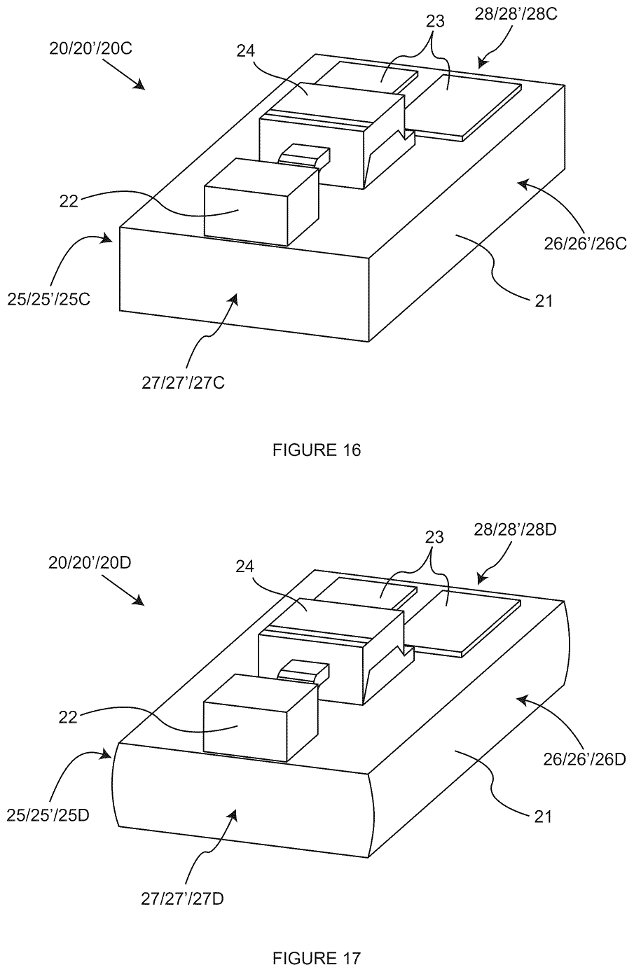

FIGS. 16 and 17 illustrate, separately, isometric views of the third and fourth example embodiments of the light emitting module (20C/20D), which can be received by a suitable aperture (11) of a body (10/10′/10A/10B), such as the slightly undersized apertures (11) of the first and second examples of the generic/further generic lighting assemblies (1A/1B). The light emitting modules (20C/20D) shown in FIGS. 16 and 17 are similar to the light emitting modules (20A/20B) shown in FIGS. 14 and 15, and thus their obvious similarities will not be described again hereinafter.

However, as illustrated in FIG. 16, the third example embodiment of the light emitting module (20C) has the particular form wherein the first and second side regions (25C, 26C) of the MCPCB (21) include edges which are created by a straight cut process, and wherein the front and rear regions (27C, 28C) of the MCPCB (21) are not tapered or chamfered.

In contrast, as illustrated in FIG. 17, the fourth example embodiment of the light emitting module (20D) has the particular form wherein the first and second side regions (25D, 26D) of the MCPCB (21) include edges which are created using shaped router tools, or commonly known in the industry as fingernail or convex edge tools, and wherein the front and rear regions (27D, 28D) of the MCPCB (21) are not tapered or chamfered. The edges created by such fingernail or convex edge tools are herein referred to as the fingernail-shaped or convex-shaped edges.

When it comes to optimizing integration with the slightly undersized aperture (11), the fingernail-shaped or convex-shaped edges of the first and second side regions (25D, 26D) of the MCPCB (21) provide an advantage over V-cut, straight cut or routed cut edges, by ensuring an almost perfect match between the radius of the interfacing fingernail-shaped or convex-shaped edges and the slightly undersized aperture (11), and therefore leads to the best possible conductivity between the MCPCB (11) and the body (10/10′/10A/10B).

In FIGS. 14 to 17, it is shown that there may be other components which are mounted on the MCPCB (21) other than the light emitting element(s) or LED(s) (22). For example, there may be one or more combination of, but not limited to, a surface mount device (SMD) connector (23), a resistor, a shunt, or one or more other SMD components (24) mounted on the MCPCB (21). The resistors, shunts, or any other SMD components (24) may be required for the control and/or protection of the light emitting module (20/20′/20A/20B/20C/20D).

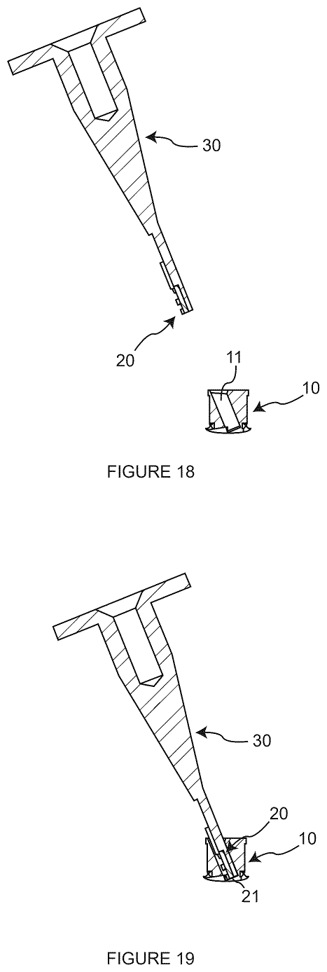

FIGS. 18 to 20 show an improved assembly method or process for the first exemplary embodiment of the lighting assembly (1), but can also be used to assemble the other examples/embodiments (1′/1A/1B) described herein.

In a first step of the improved assembly method or process, FIG. 18 illustrates the lighting assembly (1) being in a substantially detached or separated state, in which the light emitting module (20) is initially attached or loaded in a jig (30).

In a second step of the improved assembly method or process, FIG. 19 illustrates the jig (30) pressing the light emitting module (20), particularly the MCPCB (21), into the aperture (11) of the body (10). Preferably, the light emitting module (20) is received by the aperture (11) of the body (10) via an interference fit or press fit. In this step, the MCPCB (21) is slightly deformed in the slightly undersized aperture (11).

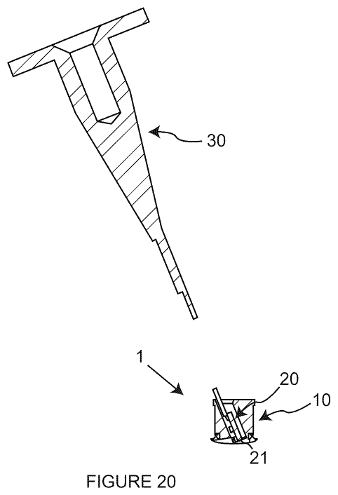

In a third step of the improved assembly method or process, FIG. 20 illustrates the light emitting module (20) being detached or extracted from the jig (30), leaving the light emitting module (20) inserted in the aperture (11) of the body (10). In this step, the MCPCB (21) is also slightly deformed in the slightly undersized aperture (11).

In an optional step which may occur after the third step of the improved assembly method or process, the remainder of the aperture (11) of the body (10) is filled a thermally adhesive potting compound, or epoxy (12), similar to that shown in FIG. 24. The epoxy (12) may be preferably made of a substantially thermally conductive material such as ceramic, and may further be preferably made of a substantially electrically insulative material, so as to not damage the SMD components (22, 23) that are mounted to the MCPCB (21).

FIGS. 1 and 2 illustrate isometric and cross-sectional views of the first embodiment of the lighting assembly (1) shown in FIGS. 3 to 5, when it is mounted to a fitting aperture, such as in a handrail or tube (100). Particularly, when the lighting assembly (1) is fitted through an opening of the handrail or tube (100), the bottom of the lighting assembly (1) remains flush with, or at least does not protrude out of, the surface of the handrail or tube (100).

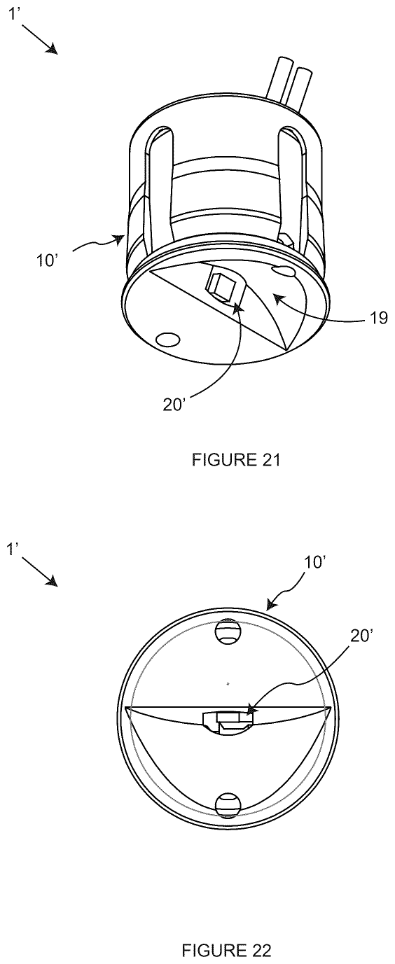

In FIGS. 21 to 24, a second exemplary embodiment of the lighting assembly (1′) is illustrated. As shown, the lighting assembly (1′) is in a substantially attached or connected state, which is when the light emitting module (20′) is fitted into the aperture (11) of the body (10′) of the lighting assembly (1′). Particularly, the body (10′) of the second exemplary embodiment of the lighting assembly (1′) has a flat bottom with a recess (19), which allows the light emitting module (20′) to emit light in the direction of the “Light Output” arrows, as shown in FIGS. 21 and 24.

Typically, the aperture (11) of the body (10′) is a slightly undersized hole or recess, such that the internal diameter of the aperture (11) is substantially equal to or slightly less than the width of the MCPCB (21). As a result, the MCPCB (21) is caused to slightly deform, when the light emitting module (20′) is fitted into the aperture (11) of the body (10′), so that it can fit in the internal diameter of the slightly undersized aperture (11). Preferably, the light emitting module (20′) is received by the aperture (11) of the body (10′) via an interference fit or press fit.

Similar to the first exemplary embodiment/first example/second example of the lighting assembly (1/1A/1B) shown in FIGS. 1 to 13, and the first to fourth example embodiments of the light emitting module (20A/20B/20C/20D) shown in FIGS. 14 to 17, the slight deformation of the MCPCB (21) ensures a greater surface contact, as well as maximum contact pressure, between the MCPCB (21) and the aperture (11), to thereby ensure greater thermal conductivity between the MCPCB (21) of the light emitting module (20′) and the body (10′). Furthermore, the light emitting module (20′) shown in FIGS. 20 to 24 may be any one of the light emitting modules (20A/20B/20C/20D) shown in FIGS. 14 to 17, and will not be further described again hereinafter.

As shown in FIGS. 20 and 24, the second exemplary embodiment of the lighting assembly (1′) enables the light emitting element (22) to be oriented perpendicularly to the axis of the aperture (11), which can be useful in some applications. Specifically, the light emitting element (22) is oriented perpendicularly to the axis of the aperture (11) in this embodiment, since the light emitting element (22) is mounted on the MCPCB (21) and emits light substantially away from the MCPCB (21), as shown by the “Light Output” arrows in FIG. 24. The light emitting element (22) may be in the form of a light emitting diode (LED).

However, one of the differences in the second exemplary embodiment is that the aperture (11) of the body (10′) is slanted/inclined, as shown in FIG. 24, as opposed to being substantially vertically disposed apertures (11) shown in FIGS. 6 to 13. The slanted/inclined aperture (11), with the help of the recess (19) of the body (10′), allows the light emitting element/LED (22) to optimally output light without having to substantially and partially dispose the light emitting module (20′) outside the body (10′), like the first and second examples of the generic/further generic lighting assemblies (1A/1B) shown in FIGS. 7, 9, 11 and 13. It is noted that the slanted/inclined aperture (11) is also used in the first exemplary embodiment of the lighting assembly (1).

Referring back to the second exemplary embodiment of the lighting assembly (1′), particularly in FIG. 24, it is shown that there may be other components which are mounted on the MCPCB (21) other than the light emitting element(s) or LED(s) (22). For example, there may be one or more combination of, but not limited to, a surface mount device (SMD) connector (23), a resistor, a shunt, or one or more other SMD components (24) mounted on the MCPCB (21). The resistors, shunts, or any other SMD components (24) may be required for the control and/or protection of the light emitting module (20′).

Furthermore, FIG. 24 shows that the SMD connector(s) (23) may further be joined to one or more wires (14) via one or more solder joints (13), with the wires (14) interfacing with a controller or power source, and, that the remainder of the aperture (11) of the body (10′) is filled with a thermally adhesive potting compound, or epoxy (12), that is preferably made of a substantially thermally conductive material such as ceramic. It is further preferred that the epoxy (12) is also electrically insulative, so as to not damage the SMD components (22, 23) that are mounted to the MCPCB (21).

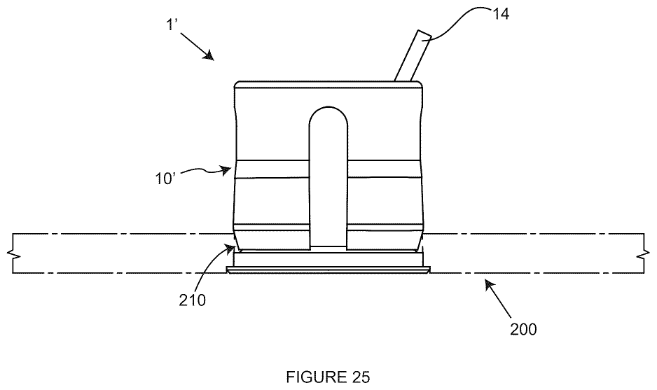

FIG. 25 shows the typical use of the lighting assembly (1′) shown in FIGS. 20 to 24. Particularly, the lighting assembly (1′) is fitted into an article (200), having a flat surface, through an opening (210) of the article (200). Preferably, the lighting assembly (1′) is seated flush with the flat surface of the article (200). It is noted that the article (200) may be a handrail or tube.

In another exemplary embodiment of the lighting assembly (not shown), the light emitting elements, or LEDs, may be located on the end (i.e., front or rear regions) of a double-sided MCPCB. This can be made possible using LED emitter types with a centrally located, electrically isolated thermal pad, such as the commonly used high power emitters based on the 3535 packages like, for example, the Cree XP range. This style of LED emitter enables the use of Direct Thermal Path (DTP) attachment of the thermal pad to the metal core (typically copper) of the MCPCB. Further, the anode and cathode pads may be connected via the copper tracks on both sides of the double-sided board.

This exemplary embodiment of the lighting assembly enables the light emitting element to be oriented parallel to the axis of the aperture, which can be useful in some applications.

In the exemplary embodiments described, it is preferred that the MCPCB is substantially narrow and rectangular-shaped, the maximum power of the light emitting element or LED is in the range of 1 to 10 Watts, and the dimension of the light emitting element or LED is approximately 1.6 mm×1.6 mm. In addition, it is preferred that the MCPCB is partially made of copper, gold, silver, aluminium and/or platinum.

In addition, it is preferred that the invention is typically applied to small luminaries, but it should be noted that the invention may also readily be applied to other luminaires where space and/or access is limited to the personnel, who may be, but not limited to, a toolmaker or an installer.

From the embodiments described above and the drawings, the person skilled in the art would understand that there is sufficient space of the remainder of the aperture (11), when the lighting assembly (1/1′) is in the attached or connected state, for electrical connections to be made, such as that shown in FIG. 24. However, the person skilled in the art would understand that there may also be embodiments where a portion of the MCPCB (21), with the SMD connectors (23), are located outside the aperture (11) of body (10), and, that electrical connections are made outside the aperture (11) of the body (10/10′) of the lighting assembly (1/1′). In other words, the technical aim of the invention can still be achieved with electrical connections with the MCPCB being made outside the small luminaire.

Throughout the specification, the term “aperture” has been used, which implies that the body of the lighting assembly must include a through hole or the like in order for aims of the invention to be achieved. However, the person skilled in the art would understand that the aims of the invention can be achieved by having the body of the lighting assembly include a recess with an end wall instead, and reversely fitting the light emitting module from bottom to top into the body, in the same orientation as those shown in FIGS. 7 and 11 for example.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, addition and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g. aspects of one embodiment may be combined with aspects of another embodiment to realise yet other embodiments. Further, each independent feature or component of any given assembly may constitute an additional embodiment.

The reference numerals in the following claims do not in any way limit the scope of the respective claims.

In the forgoing description of preferred embodiments, specific terminology has been resorted to for the sake of clarity. However, the invention is not intended to be limited to specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

1-61. (canceled)

62. A lighting assembly including:
a body including an aperture, the body being formed of a substantially thermally conductive material;
a light emitting module adapted to be inserted in said aperture, the light emitting module including:
a metal core printed circuit board; and
a light emitting element mounted to the metal core printed circuit board,
wherein the aperture is sized such that an internal diameter of the aperture is substantially equal to or less than a width of the metal core printed circuit board, such that, the light emitting module is installed via an interference fit into the aperture of the body to thereby at least partially deform the metal core printed circuit board,
wherein, when the light emitting module is inserted, the longitudinal axis of the metal core printed circuit board is substantially parallel to the axis of the aperture.

63. A lighting assembly according to claim 62, wherein the aperture is tapered or chamfered, and/or,
wherein the leading edge of the metal core printed circuit board is tapered or chamfered.

64. A lighting assembly according to claim 62, wherein the light emitting element is mounted on the metal core printed circuit board, or,
wherein the light emitting element is mounted to an end of the metal core printed circuit board, and,
wherein preferably, the light emitting element is thermally connected to the metal core printed circuit board via a substantially centrally located and electrically isolated thermal pad.

65. A lighting assembly according to claim 62, wherein the orientation of the light emitting element is substantially perpendicular to the axis of the aperture, or,
wherein the orientation of the light emitting element is substantially parallel to the axis of the aperture.

66. A lighting assembly according to claim 62, wherein the metal core printed circuit board includes one or more substantially straight cut or routed cut edges, and/or,
wherein the metal core printed circuit board includes one or more V-cut or V-score edges, and/or,
wherein the metal core printed circuit board includes one or more fingernail-shaped or convex-shaped edges.

67. A lighting assembly according to claim 62, wherein the metal core printed circuit board of the light emitting module is further mounted with any one or combination of:
a surface mount device connector;
a resistor;
a shunt; and
one or more other surface mount device components.

68. A lighting assembly according to claim 62, wherein the width of the metal core printed circuit board is substantially equal to or less than 10 mm.

69. A lighting assembly according to claim 62, wherein the lighting emitting element is a light emitting diode, and,
wherein the maximum power of the light emitting diode is preferably in the range of 1 to 10 Watts, and/or,
wherein the dimension of the light emitting diode is preferably approximately 1.6 mm×1.6 mm.

70. A lighting assembly according to claim 62, wherein the metal core printed circuit board is substantially rectangular-shaped, and/or,
wherein the metal core printed circuit board is at least partially formed of any one or combination of copper, gold, silver, aluminium and platinum, and/or,
wherein the body is substantially formed of a metal material, including, but not limited to, any one or combination of copper, gold, silver, aluminium and platinum.

71. A body for a lighting assembly as claimed in claim 62, the body being formed of a substantially thermally conductive material and including an aperture.

72. A body according to claim 71, wherein the aperture is tapered or chamfered.

73. A body according to claim 71, wherein the body is substantially formed of a metal material, including, but not limited to, any one or combination of copper, gold, silver, aluminium and platinum.

74. A light emitting module for a lighting assembly as claimed in claim 62, including:
a metal core printed circuit board; and
a light emitting element mounted to the metal core printed circuit board.

75. A light emitting module according to claim 74, wherein the leading edge of the metal core printed circuit board is tapered or chamfered.

76. A light emitting module according to claim 74, wherein the light emitting element is mounted on the metal core printed circuit board, or,
wherein the lighting element is mounted to an end of the metal core printed circuit board, and,
wherein preferably, the light emitting element is thermally connected to the metal core printed circuit board via a substantially centrally located and electrically isolated thermal pad.

77. A light emitting module according to claim 74, wherein the metal core printed circuit board includes one or more substantially straight cut or routed cut edges, and/or,
wherein the metal core printed circuit board includes one or more V-cut or V-score edges, and/or,
wherein the metal core printed circuit board includes one or more fingernail-shaped or convex-shaped edges.

78. A light emitting module according to claim 74, wherein the metal core printed circuit board of the light emitting module is further mounted with any one or combination of:
a surface mount device connector;
a resistor;
a shunt; and
one or more other surface mount device components.

79. A light emitting module according to claim 74, wherein the metal core printed circuit board has a width of substantially equal to or less than mm.

80. A light emitting module according to claim 74, wherein the lighting emitting element is a light emitting diode, and,
wherein the maximum power of the light emitting diode is preferably in the range of 1 to 10 Watts, and/or,
wherein the dimension of the light emitting diode is preferably approximately 1.6 mm×1.6 mm.

81. A light emitting module according to claim 74, wherein the metal core printed circuit board is substantially rectangular-shaped, and/or,
wherein the metal core printed circuit board is at least partially formed of any one or combination of copper, gold, silver, aluminium and platinum.
